(19) United States
(12) Patent Application Publication
(10) Pub. No.: US 2022/0239226 A1
(43) Pub. Date: Jul. 28, 2022

(54) SWITCHING AMPLIFIER ARCHITECTURE WITH MULTIPLE SUPPLIES

(71) Applicant: QUALCOMM Incorporated, San Diego, CA (US)

(72) Inventors: Subbarao Surendra CHAKKIRALA, San Jose, CA (US); Sherif GALAL, Irvine, CA (US); Guoqing MIAO, San Diego, CA (US)

(21) Appl. No.: 17/161,299

(22) Filed: Jan. 28, 2021

(51) Int. Cl. H02M 3/158; H02M 1/088

(52) U.S. Cl. CPC H02M 3/1582; H03F 3/21; H03F 2200/03; H02M 1/088

(57) ABSTRACT

Certain aspects of the present disclosure are directed to an apparatus for voltage regulation. The apparatus generally includes a first switch, an inductive element, the first switch being coupled between a first voltage rail and a first terminal of the inductive element, a second switch coupled between a second voltage rail and the first terminal of the inductive element, a third switch coupled between a second terminal of the inductive element and a reference potential node, and a fourth switch coupled between the second terminal of the inductive element and an output node.

### FIELD

The present disclosure relates to power management, and more specifically, to circuitry for a switching amplifier.

### BACKGROUND

A speaker is a transducer that produces a pressure wave in response to an input electrical signal, and thus, sound is generated. The speaker input signal may be produced by an audio amplifier that receives a relatively lower voltage analog audio signal and generates an amplified signal to drive the speaker. A dynamic loudspeaker is typically composed of a lightweight diaphragm (a cone) connected to a rigid basket (a frame) via a flexible suspension (often referred to as a spider) that constrains a voice coil to move axially through a cylindrical magnetic gap. When the input electrical signal is applied to the voice coil, a magnetic field is created by the electric current in the coil, thereby forming a linear electric motor. By changing the electrical signal from the audio amplifier, the mechanical force generated by the interaction between the magnet and the voice coil is modulated and causes the cone to move back and forth, thereby creating the pressure waves interpreted as sound.

### SUMMARY

Certain aspects of the present disclosure are generally directed to circuitry and techniques for voltage regulation using multiple supplies.

Certain aspects of the present disclosure are directed to an apparatus for voltage regulation. The apparatus generally includes a first switch, an inductive element, the first switch being coupled between a first voltage rail and a first terminal of the inductive element, a second switch coupled between a second voltage rail and the first terminal of the inductive element, a third switch coupled between a second terminal of the inductive element and a reference potential node, and a fourth switch coupled between the second terminal of the inductive element and an output node.

Certain aspects of the present disclosure are directed to a method for voltage regulation. The method generally includes comparing an output voltage at an output node to a reference voltage, and regulating the output voltage by controlling a plurality of switches of a switching power supply based on the comparison. The switching power supply may include a first switch of the plurality of switches, an inductive element, the first switch being coupled between a first voltage rail and a first terminal of the inductive element, a second switch of the plurality of switches coupled between a second voltage rail and the first terminal of the inductive element, a third switch of the plurality of switches coupled between a second terminal of the inductive element and a reference potential node, and a fourth switch of the plurality of switches coupled between the second terminal of the inductive element and the output node.

Certain aspects of the present disclosure are directed to an apparatus for voltage regulation. The apparatus generally includes an inductive element, means for selectively coupling a first terminal of the inductive element to a first voltage rail, means for selectively coupling the first terminal of the inductive element to a second voltage rail, means for selectively coupling a second terminal of the inductive element to a reference potential node, and means for selectively coupling the second terminal of the inductive element to an output node.

### BRIEF DESCRIPTION OF THE DRAWINGS

FIG. 1 illustrates an example audio amplifier system, in accordance with certain aspects of the present disclosure.

FIG. 2 illustrates a voltage regulation system having a switching power supply, in accordance with certain aspects of the present disclosure.

FIG. 3 illustrates an example technique for operating the switching power supply using a bypass mode, a buck mode, and a boost mode, in accordance with certain aspects of the present disclosure.

FIG. 4 illustrates an example technique for operating the switching power supply using a first bypass mode, a second bypass mode, and a boost mode, in accordance with certain aspects of the present disclosure.

FIG. 5 illustrates an example technique for operating the switching power supply using a bypass mode, a first boost mode, and a second boost mode, in accordance with certain aspects of the present disclosure.

FIG. 6 is a flow diagram illustrating example operations for voltage regulation, in accordance with certain aspects of the present disclosure.

### DETAILED DESCRIPTION

Certain aspects of the present disclosure are generally directed to circuitry and techniques for voltage regulation operating from multiple voltage rails. For example, certain aspects provide a switching power supply configurable in a bypass mode, a buck mode, or a boost mode, depending on a reference voltage.

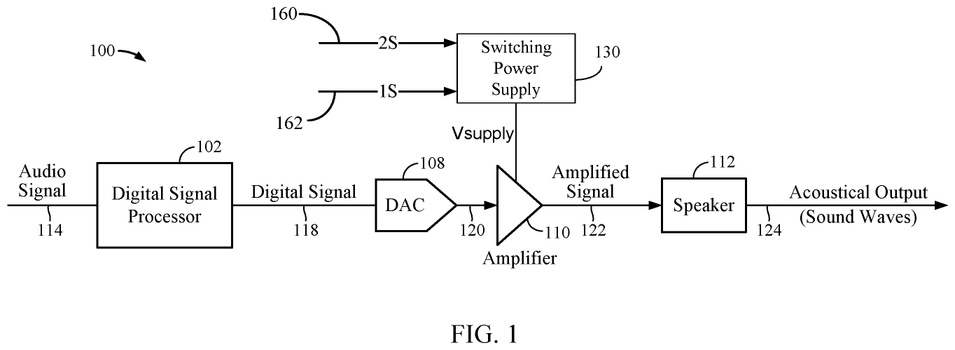

FIG. 1 illustrates an example audio amplifier system 100, in accordance with certain aspects of the present disclosure. As illustrated, a digital signal processor (DSP) 102 may receive and process audio signals 114 (e.g., a digital audio signal), for example, by applying a digital filter aimed at increasing audio quality. The processed digital signal 118 produced by the DSP (or a further processed version thereof) may be converted to an analog signal 120 using a digital-to-analog converter (DAC) 108. In certain aspects, the DAC may be implemented as part of the DSP 102 or an amplifier 110. For example, the amplifier 110 may be a class-H or class-G power amplifier. In certain aspects, the analog signal 120 may be amplified using the amplifier 110 to generate the amplified signal 122. The amplified signal 122 may drive a speaker 112 to produce an acoustic output (e.g., sound waves) 124. A supply voltage of the amplifier 110 may be generated by a switching power supply 130. The switching power supply may provide a regulated output based on multiple voltage rails 160, 162. The voltage rail 162 may be generated using a battery, also referred to as voltage rail 1S, and the voltage rail 160 may be generated using two batteries in series, also referred to as voltage rail 2S. In some aspects, the voltage rails 160, 162 may be any two different voltage inputs, where voltage at voltage rail 160 is greater than the voltage at voltage rail 162. Although an audio application is described with respect to FIG. 1 to facilitate understanding, aspects of the present disclosure can be used for any other suitable application involving voltage regulation.

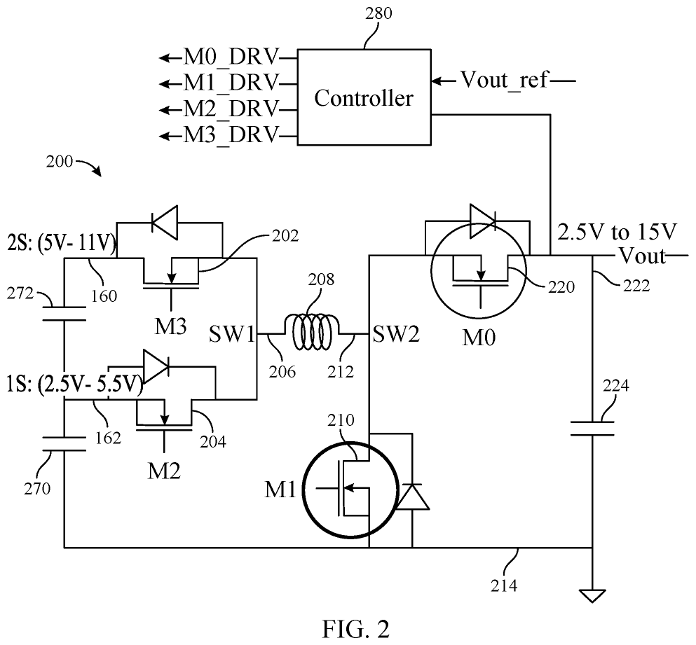

FIG. 2 illustrates a voltage regulation system having a switching power supply 200 (e.g., corresponding to switching power supply 130), in accordance with certain aspects of the present disclosure. The switching power supply 200 includes a switch 202 (e.g., implemented by transistor M3) coupled between the voltage rail 160 and a terminal 206 of an inductive element 208. The switching power supply 200 also includes a switch 204 (e.g., implemented by transistor M2) coupled between the voltage rail 162 and the terminal 206 of the inductive element 208. In some implementations (e.g., involving two batteries in series with equal voltages), the voltage of the voltage rail 160 (e.g. 5 to 11 V) may be double that of the voltage at voltage rail 162 (e.g., 2.5 to 5.5 V). As illustrated, a switch 210 (e.g., implemented by transistor M1) may be coupled between another terminal 212 of the inductive element 208 and a reference potential node 214 (e.g., electric ground) for the switching power supply 200. A switch 220 (e.g., implemented by transistor M0) may be coupled between the terminal 212 of the inductive element 208 and an output node 222 providing an output voltage (Vout). In some aspects, Vout may be the supply voltage (Vsupply) for the amplifier 110, as described. In some implementations, Vout may range between 2.5 to 15 V, as illustrated.

As illustrated, a capacitive element 270 may be coupled between the voltage rail 162 and the reference potential node 214, and a capacitive element 272 may be coupled between the voltage rail 160 and the voltage rail 162. Moreover, an output capacitive element 224 may be coupled between the output node 222 and the reference potential node 214.

As illustrated, the voltage regulation system may also include a controller 280 that may receive Vout (or a processed version thereof) and an output voltage reference (Vout_ref). The controller may compare Vout and Vout_ref and, based on the comparison, generate a drive signal (M0_DRV) to drive switch 202, a drive signal (M1_DRV) to drive switch 210, a drive signal (M2_DRV) to drive switch 204, and a drive signal (M3_DRV) to drive switch 202. The controller may, in some modes of operation, generate the drive signals in an attempt to match Vout to Vout_ref, as described in more detail herein.

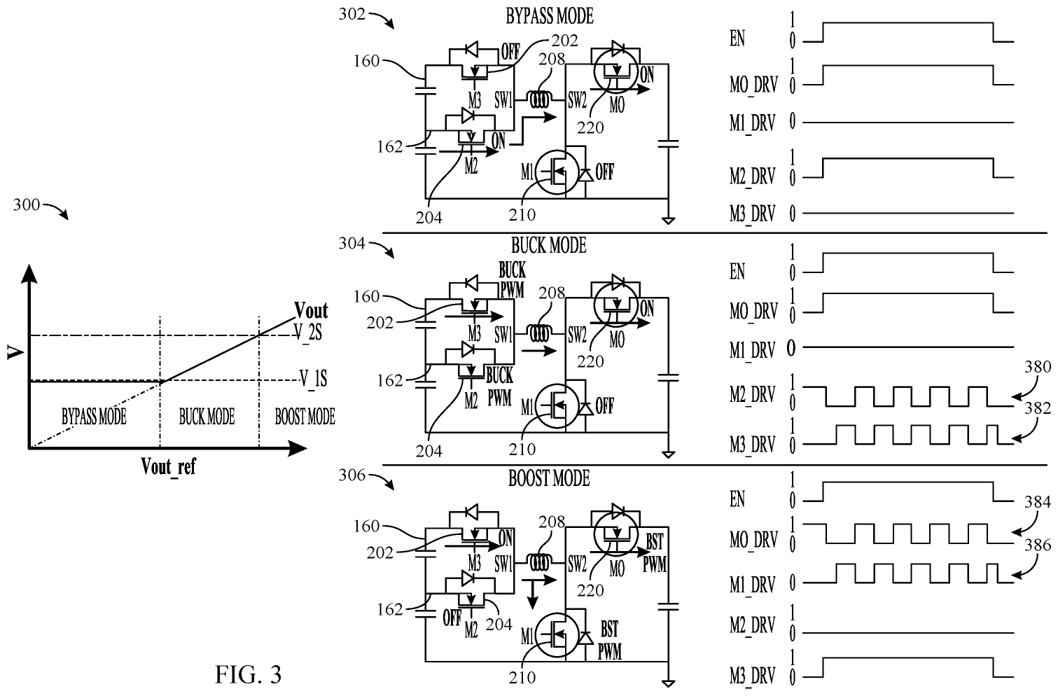

FIG. 3 illustrates an example technique for operating the switching power supply 200 using a bypass mode, a buck mode, and a boost mode, in accordance with certain aspects of the present disclosure. As illustrated in graph 300, when Vout_ref is less than the voltage (V_1S) at voltage rail 162 (1S), the switching power supply 200 may be configured in the bypass mode as shown by bypass configuration 302. For example, during bypass mode, switches 204, 220 may be closed, and switches 202, 210 may be opened. For example, M0_DRV and M2_DRV may be logic high, and M1_DRV and M3_DRV may be logic low, as illustrated. Therefore, the output node 222 may be effectively electrically shorted to the voltage rail 162. Consequently, Vout may be equal to V_1S while the switching power supply 200 is in the bypass mode. During bypass mode, current through switch 204 flows across inductive element 208 and switch 220, as illustrated.

As illustrated in graph 300, when Vout_ref is less than the voltage (V_2S) at voltage rail 160 (2S) and greater than the voltage (V_1S) at voltage rail 162 (1S), the switching power supply 200 may be operated in a buck mode as shown by the buck configuration 304. For example, during buck mode, switch 220 may be closed, and switch 210 may be opened. For example, M0_DRV may be logic high, and M1_DRV may be logic low, as illustrated. M2_DRV and M3_DRV may be pulse width modulated (PWMed) to regulate Vout to be equal to Vout_ref. That is, switch 204 may be driven by PWM signal 380, and switch 202 may be driven by PWM signal 382. Therefore, Vout may be equal to Vout_ref while the switching power supply 200 is in the buck mode.

As illustrated in graph 300, when Vout_ref is greater than the voltage (V_2S) at voltage rail 162 (2S), the switching power supply 200 may be operated in a boost mode as shown by the boost configuration 306. For example, during boost mode, switch 202 may be closed, and switch 204 may be opened. That is, M2_DRV may be logic low, and M3_DRV may be logic high, as illustrated. M0_DRV and M1_DRV may be PWMed to regulate Vout to be equal to Vout_ref. That is, switch 220 may be driven by PWM signal 384, and switch 210 may be driven by PWM signal 386. Therefore, Vout may be equal to Vout_ref while the switching power supply 200 is in the boost mode.

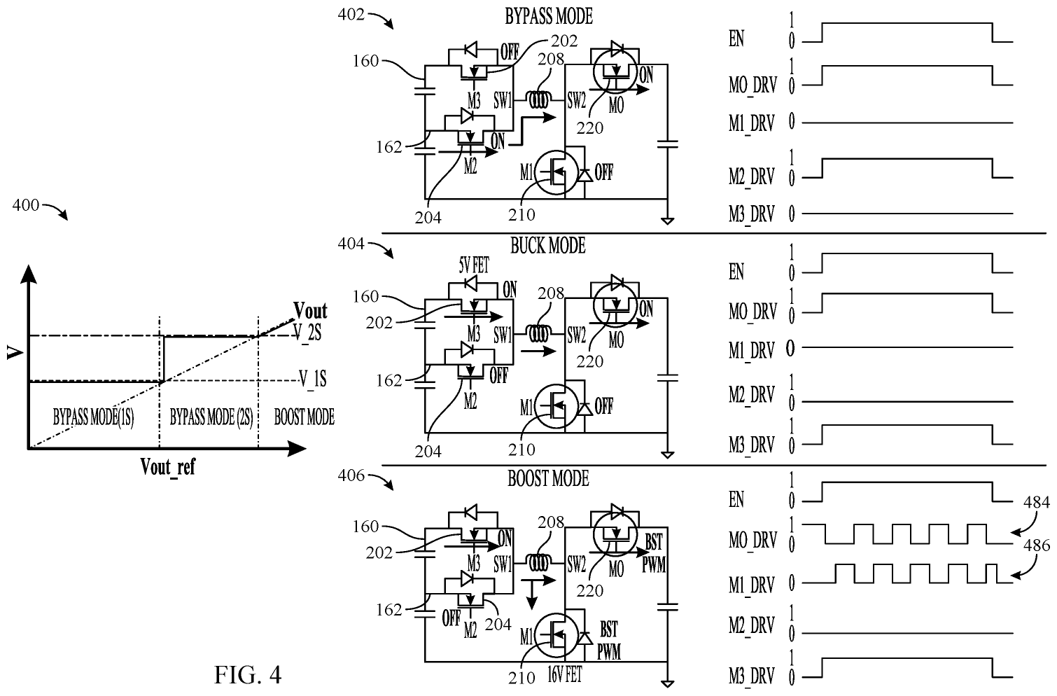

FIG. 4 illustrates an example technique for operating the switching power supply 200 using a first bypass mode, a second bypass mode, and a boost mode, in accordance with certain aspects of the present disclosure. As illustrated in graph 400, when Vout_ref is less than the voltage (V_1S) at voltage rail 162 (1S), the switching power supply 200 may be operated in the bypass mode (also referred to as “bypass-mode 1S”) as shown by the bypass configuration 402. For example, during the first bypass mode, switches 204, 220 may be closed, and switches 202, 210 may be opened. That is, M0_DRV and M2_DRV may be logic high, and M1_DRV and M3_DRV may be logic low, as illustrated. Therefore, the output node 222 may be effectively electrically shorted to the voltage rail 162 such that Vout is equal to V_1S while the switching power supply 200 is in the first bypass mode. During the first bypass mode, current through switch 204 flows across inductive element 208 and switch 220, as illustrated.

As illustrated in graph 400, when Vout_ref is less than the voltage (V_2S) at voltage rail 160 (2S) and greater than the voltage (V_1S) at voltage rail 162 (1S), the switching power supply 200 may be operated in a second bypass mode (also referred to as “bypass-mode 2S”) as shown by the bypass configuration 404. For example, during the second bypass mode, switches 202, 220 may be closed, and switches 204, 210 may be opened. That is, M0_DRV and M3_DRV may be logic high, and M1_DRV and M2_DRV may be logic low, as illustrated. Therefore, the output node 222 may be electrically shorted to the voltage rail 160 such that Vout is equal to V_2S while the switching power supply 200 is in the second bypass mode. During the second bypass mode, current through switch 202 flows across inductive element 208 and switch 220, as illustrated.

As illustrated in graph 400, when Vout_ref is greater than the voltage (V_2S) at voltage rail 160 (2S), the switching power supply 200 may be operated in a boost mode as shown by boost configuration 406. For example, during boost mode, switch 202 may be closed, and switch 204 may be opened. That is, M2_DRV may be logic low, and M3_DRV may be logic high, as illustrated. M0_DRV and M1_DRV may be PWMed to regulate Vout to be equal to Vout_ref. That is, switch 220 may be driven by PWM signal 484, and switch 210 may be driven by PWM signal 486. Therefore, Vout may be equal to Vout_ref while the switching power supply 200 is in the boost mode.

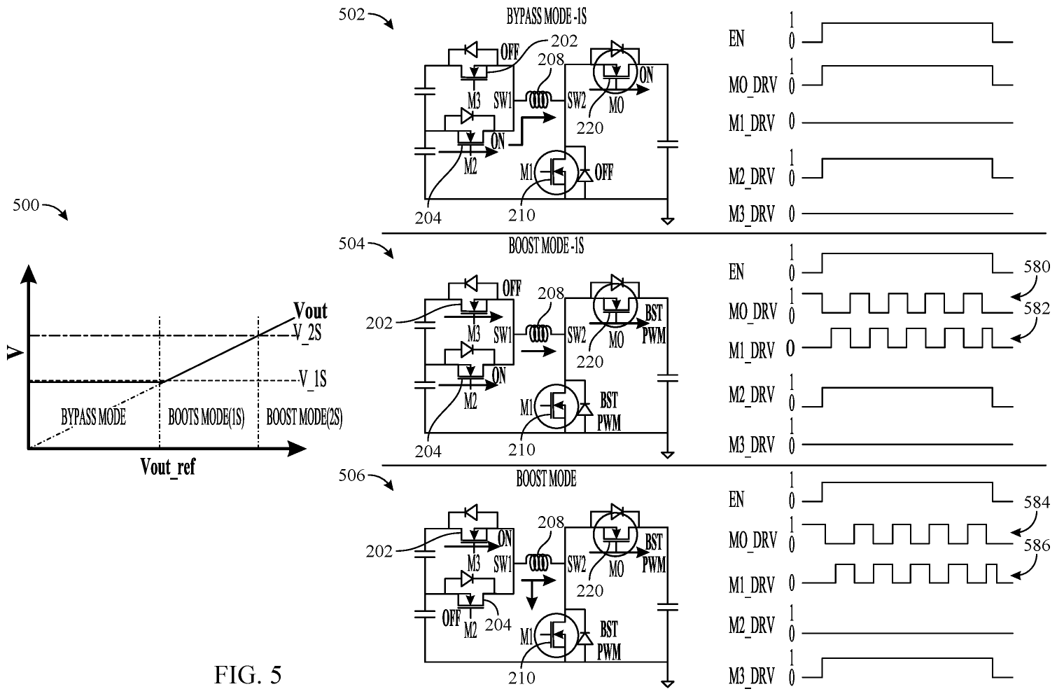

FIG. 5 illustrates an example technique for operating the switching power supply 200 using a bypass mode, a first boost mode, and a second boost mode, in accordance with certain aspects of the present disclosure. The operation of the switching power supply 200 as described with respect to FIG. 5 may be referred to as a boost-boost mode of operation. As illustrated in graph 500, when Vout_ref is less than the voltage (V_1S) at voltage rail 162 (1S), the switching power supply 200 may be operated in the bypass mode as shown by the bypass configuration 502. For example, during the bypass mode, switches 204, 220 may be closed, and switches 202, 210 may be opened. That is, M0_DRV and M2_DRV may be logic high, and M1_DRV and M3_DRV may be logic low, as illustrated. Therefore, the output node 222 may be effectively electrically shorted to the voltage rail 162 such that Vout is equal to V_1S while the switching power supply 200 is in the bypass mode. During the bypass mode, current through switch 204 flows across inductive element 208 and switch 220, as illustrated.

As illustrated in graph 500, when Vout_ref is less than the voltage (V_2S) at voltage rail 160 (S2) and greater than the voltage (V_1S) at voltage rail 162 (1S), the switching power supply 200 may be operated in a first boost mode (also referred to as “boost-mode 1S”) as shown by the boost configuration 504. For example, during the first boost mode, switch 204 may be closed, and switch 202 may be opened. That is, M3_DRV may be logic low, and M2_DRV may be logic high, as illustrated. M0_DRV and M1_DRV may be PWMed to regulate Vout to be equal to Vout_ref. That is, switch 220 may be driven by PWM signal 580, and switch 210 may be driven by PWM signal 582. Therefore, Vout may be equal to Vout_ref while the switching power supply 200 is in the first boost mode.

As illustrated in graph 500, when Vout_ref is greater than the voltage (V_2S) at voltage rail 160 (2S), the switching power supply 200 may be operated in a second boost mode (also referred to as “boost-mode 2S”) as shown by the second boost configuration 506. For example, during the second boost mode, switch 202 may be closed, and switch 204 may be opened. That is, M2_DRV may be logic low, and M3_DRV may be logic high, as illustrated. M0_DRV and M1_DRV may be PWMed to regulate Vout to be equal to Vout_ref. That is, switch 220 may be driven by PWM signal 584, and switch 210 may be driven by PWM signal 586. Therefore, Vout may be equal to Vout_ref while the switching power supply 200 is in the boost mode.

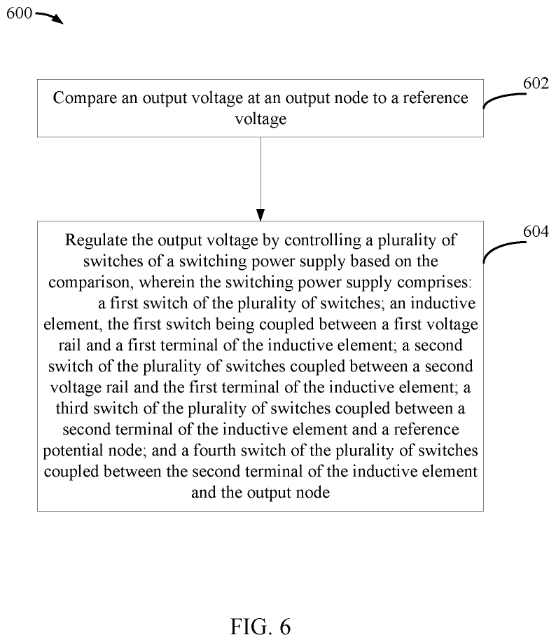

FIG. 6 is a flow diagram illustrating example operations 600 for voltage regulation, in accordance with certain aspects of the present disclosure. The operations 600 may be performed, for example, by a voltage regulation system, such as the switching power supply 200 and the controller 280.

The operations 600 begin, at block 602, with the voltage regulation system comparing an output voltage (Vout) at an output node (e.g., output node 222) to a reference voltage (Vout_ref), and at block 604, regulating the output voltage by controlling a plurality of switches of a switching power supply based on the comparison. The switching power supply may include a first switch (e.g., switch 204) of the plurality of switches and an inductive element (e.g., inductive element 208), the first switch being coupled between a first voltage rail (e.g., voltage rail 162) and a first terminal of the inductive element. The switching power supply may also include a second switch (e.g., switch 202) of the plurality of switches coupled between a second voltage rail (e.g., voltage rail 160) and the first terminal of the inductive element. In some aspects, the switching power supply may also include a third switch (e.g., switch 210) of the plurality of switches coupled between a second terminal of the inductive element and a reference potential node (e.g., reference potential node 214), and a fourth switch (e.g., switch 220) of the plurality of switches coupled between the second terminal of the inductive element and the output node.

In some aspects, if the reference voltage is less than a voltage at the first voltage rail, controlling the plurality of switches may include closing the first switch, opening the second switch, opening the third switch, and closing the fourth switch. In some aspects, if the reference voltage is greater than a voltage at the first voltage rail and less than a voltage at the second voltage rail, controlling the plurality of switches may include opening the first switch, closing the second switch, opening the third switch, and closing the fourth switch.

In some aspects, controlling the plurality of switches may include configuring the switching power supply as a buck converter if the reference voltage is greater than a voltage at the first voltage rail of the switching power supply and less than a voltage at the second voltage rail of the switching power supply. For example, if the reference voltage is greater than a voltage at the first voltage rail and less than a voltage at the second voltage rail, controlling the plurality of switches may include opening the third switch, closing the fourth switch, controlling the first switch via a first pulse-width-modulated signal, and controlling the second switch via a second pulse-width-modulated signal.

In some aspects, if the reference voltage is greater than a voltage at the first voltage rail of the switching power supply and less than a voltage at the second voltage rail of the switching power supply, controlling the plurality of switches may include configuring the switching power supply as a boost converter while the inductive element is electrically shorted to the first voltage rail through the first switch. For example, if the reference voltage is greater than a voltage at the first voltage rail and less than a voltage at the second voltage rail, controlling the plurality of switches may include closing the first switch, opening the second switch, controlling the third switch via a first pulse-width-modulated signal, and controlling the fourth switch via a second pulse-width-modulated signal.

In certain aspects, if the reference voltage is greater than a voltage at the second voltage rail, controlling the plurality of switches may include configuring the switching power supply as a boost converter while the inductive element is electrically shorted to the second voltage rail through the second switch. For example, if the reference voltage is greater than a voltage at the second voltage rail, controlling the plurality of switches may include opening the first switch, closing the second switch, controlling the third switch via a first pulse-width-modulated signal, and controlling the fourth switch via a second pulse-width-modulated signal.

In certain aspects, voltages at the first voltage rail and the second voltage rail may be generated via a first battery and a second battery. In some aspects, each of the first switch, the second switch, the third switch, and the fourth switch may be a field-effect transistor (FET). For example, transistors M0, M1, M2, M3 may be implemented using n-channel FETs (NFETs). In some implementations, the transistors M0, M2, M3 may be implemented using p-channel field-effect transistors (PFETs). In this case, the drive signals (e.g., M0_DRV, M2_DRV, M3_DRV) for transistors M0, M2, M3 may be complementary to those described and illustrated in FIGS. 3-5.

The aspects described herein provide a voltage regulation system with improved power efficiency as compared to conventional implementations, especially for applications such as audio that operate at low power for extended periods of time.

### EXAMPLE ASPECTS

Aspect 1. An apparatus for voltage regulation, comprising: a first switch; an inductive element, the first switch being coupled between a first voltage rail and a first terminal of the inductive element; a second switch coupled between a second voltage rail and the first terminal of the inductive element; a third switch coupled between a second terminal of the inductive element and a reference potential node; and a fourth switch coupled between the second terminal of the inductive element and an output node.

Aspect 2. The apparatus of aspect 1, further comprising a controller configured to: compare an output voltage at the output node to a reference voltage; and regulate the output voltage by controlling the first switch, the second switch, the third switch, and the fourth switch, based on the comparison.

Aspect 3. The apparatus of aspect 2, wherein, if the reference voltage is less than a voltage at the first voltage rail, the controller is configured to: close the first switch; open the second switch; open the third switch; and close the fourth switch.

Aspect 4. The apparatus of aspect 2, wherein, if the reference voltage is greater than a voltage at the first voltage rail and less than a voltage at the second voltage rail, the controller is configured to: open the first switch; close the second switch; open the third switch; and close the fourth switch.

Aspect 5. The apparatus of any one of aspects 2 or 4, wherein, if the reference voltage is greater than a voltage at the first voltage rail and less than a voltage at the second voltage rail, the controller is configured to: open the third switch; close the fourth switch; control the first switch via a first pulse-width-modulated signal; and control the second switch via a second pulse-width-modulated signal.

Aspect 6. The apparatus of one of aspects 2, 4, or 5, wherein the apparatus comprises a switching power supply configured as a buck converter if the reference voltage is greater than a voltage at the first voltage rail of the switching power supply and less than a voltage at the second voltage rail of the switching power supply.

Aspect 7. The apparatus of one of aspects 2, 4, 5, or 6, wherein, if the reference voltage is greater than a voltage at the first voltage rail and less than a voltage at the second voltage rail, the controller is configured to: close the first switch; open the second switch; control the third switch via a first pulse-width-modulated signal; and control the fourth switch via a second pulse-width-modulated signal.

Aspect 8. The apparatus of one of aspects 2, 4, 5, 6, or 7, wherein: the apparatus comprises a switching power supply; and if the reference voltage is greater than a voltage at the first voltage rail of the switching power supply and less than a voltage at the second voltage rail of the switching power supply, the switching power supply is configured as a boost converter while the inductive element is electrically shorted to the first voltage rail through the first switch.

Aspect 9. The apparatus of aspect 2, wherein, if the reference voltage is greater than a voltage at the second voltage rail, the controller is configured to: open the first switch; close the second switch; control the third switch via a first pulse-width-modulated signal; and control the fourth switch via a second pulse-width-modulated signal.

Aspect 10. The apparatus of any one of aspects 2 or 9, wherein: the apparatus comprises a switching power supply; and if the reference voltage is greater than a voltage at the second voltage rail, the switching power supply is configured as a boost converter while the inductive element is electrically shorted to the second voltage rail through the second switch.

Aspect 11. The apparatus of any one of aspects 1-10, wherein voltages at the first voltage rail and the second voltage rail are generated via a first battery and a second battery.

Aspect 12. The apparatus of any one of aspects 1-11, wherein each of the first switch, the second switch, the third switch, and the fourth switch comprises a field-effect transistor (FET).

Aspect 13. A method for voltage regulation, comprising: comparing an output voltage at an output node to a reference voltage; and regulating the output voltage by controlling a plurality of switches of a switching power supply based on the comparison, wherein the switching power supply comprises: a first switch of the plurality of switches; an inductive element, the first switch being coupled between a first voltage rail and a first terminal of the inductive element; a second switch of the plurality of switches coupled between a second voltage rail and the first terminal of the inductive element; a third switch of the plurality of switches coupled between a second terminal of the inductive element and a reference potential node; and a fourth switch of the plurality of switches coupled between the second terminal of the inductive element and the output node.

Aspect 14. The method of aspect 13, wherein, if the reference voltage is less than a voltage at the first voltage rail, controlling the plurality of switches comprises: closing the first switch; opening the second switch; opening the third switch; and closing the fourth switch.

Aspect 15. The method of aspect 13, wherein, if the reference voltage is greater than a voltage at the first voltage rail and less than a voltage at the second voltage rail, controlling the plurality of switches comprises: opening the first switch; closing the second switch; opening the third switch; and closing the fourth switch.

Aspect 16. The method of any one of aspects 13 or 15, wherein, if the reference voltage is greater than a voltage at the first voltage rail and less than a voltage at the second voltage rail, controlling the plurality of switches comprises: opening the third switch; closing the fourth switch; controlling the first switch via a first pulse-width-modulated signal; and controlling the second switch via a second pulse-width-modulated signal.

Aspect 17. The method of any one of aspects 13, 15, or 16, wherein controlling the plurality of switches comprises configuring the switching power supply as a buck converter if the reference voltage is greater than a voltage at the first voltage rail of the switching power supply and less than a voltage at the second voltage rail of the switching power supply.

Aspect 18. The method of any one of aspects 13, 15, 16, or 17, wherein, if the reference voltage is greater than a voltage at the first voltage rail and less than a voltage at the second voltage rail, controlling the plurality of switches comprises: closing the first switch; opening the second switch; controlling the third switch via a first pulse-width-modulated signal; and controlling the fourth switch via a second pulse-width-modulated signal.

Aspect 19. The method of any one of aspects 13, 15, 16, 17, or 18, wherein, if the reference voltage is greater than a voltage at the first voltage rail of the switching power supply and less than a voltage at the second voltage rail of the switching power supply, controlling the plurality of switches comprises configuring the switching power supply as a boost converter while the inductive element is electrically shorted to the first voltage rail through the first switch.

Aspect 20. The method of aspect 13, wherein, if the reference voltage is greater than a voltage at the second voltage rail, controlling the plurality of switches comprises: opening the first switch; closing the second switch; controlling the third switch via a first pulse-width-modulated signal; and controlling the fourth switch via a second pulse-width-modulated signal.

Aspect 21. The method of any one of aspects 13 or 20, wherein, if the reference voltage is greater than a voltage at the second voltage rail, controlling the plurality of switches comprises configuring the switching power supply as a boost converter while the inductive element is electrically shorted to the second voltage rail through the second switch.

Aspect 22. The method of any one of aspects 13-21, wherein voltages at the first voltage rail and the second voltage rail are generated via a first battery and a second battery.

Aspect 23. The method of any one of aspects 13-22, wherein each of the first switch, the second switch, the third switch, and the fourth switch comprises a field-effect transistor (FET).

Aspect 24. An apparatus for voltage regulation, comprising: an inductive element; means for selectively coupling a first terminal of the inductive element to a first voltage rail; means for selectively coupling the first terminal of the inductive element to a second voltage rail; means for selectively coupling a second terminal of the inductive element to a reference potential node; and means for selectively coupling the second terminal of the inductive element to an output node.

Aspect 25. The apparatus of aspect 24, further comprising: means for comparing an output voltage at the output node to a reference voltage; and means for regulating the output voltage by controlling the means for selectively coupling the first terminal of the inductive element to the first voltage rail, the means for selectively coupling the first terminal of the inductive element to the second voltage rail, the means for selectively coupling the second terminal of the inductive element to the reference potential node, and the means for selectively coupling the second terminal of the inductive element to the output node, based on the comparison.

Aspects of the present disclosure may take the form of an entirely hardware implementation, or an implementation combining software and hardware aspects that may all generally be referred to herein as a “circuit,” “module,” or “system.” The present disclosure may be a system, a method.

In certain aspects, means for selectively coupling may be a switch, such as the switch 202, 204, 210, 220, each of which may be implemented by one or more transistors. Means for comparing may include a comparator (not shown) and/or a controller, such as the controller 280. Means for regulating may include a controller, such as the controller 280.

The flowchart and block diagrams in the Figures illustrate the architecture, functionality, and operation of possible implementations of systems, methods, and according to various examples of the present disclosure. In this regard, each block in the flowchart or block diagrams may represent a module, segment. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware.

While the foregoing is directed to examples of the present disclosure, other and further examples of the disclosure may be devised without departing from the basic scope thereof, and the scope thereof is determined by the claims that follow.

What is claimed is:

1. An apparatus for voltage regulation, comprising:
a first switch;
an inductive element, the first switch being coupled between a first voltage rail and a first terminal of the inductive element;
a second switch coupled between a second voltage rail and the first terminal of the inductive element;
a third switch coupled between a second terminal of the inductive element and a reference potential node; and
a fourth switch coupled between the second terminal of the inductive element and an output node.

2. The apparatus of claim 1, further comprising a controller configured to:
compare an output voltage at the output node to a reference voltage; and
regulate the output voltage by controlling the first switch, the second switch, the third switch, and the fourth switch, based on the comparison.

3. The apparatus of claim 2, wherein, if the reference voltage is less than a voltage at the first voltage rail, the controller is configured to:
close the first switch;
open the second switch;
open the third switch; and
close the fourth switch.

4. The apparatus of claim 2, wherein, if the reference voltage is greater than a voltage at the first voltage rail and less than a voltage at the second voltage rail, the controller is configured to:
open the first switch;
close the second switch;
open the third switch; and
close the fourth switch.

5. The apparatus of claim 2, wherein, if the reference voltage is greater than a voltage at the first voltage rail and less than a voltage at the second voltage rail, the controller is configured to:
open the third switch;
close the fourth switch;
control the first switch via a first pulse-width-modulated signal; and
control the second switch via a second pulse-width-modulated signal.

6. The apparatus of claim 2, wherein the apparatus comprises a switching power supply configured as a buck converter if the reference voltage is greater than a voltage at the first voltage rail of the switching power supply and less than a voltage at the second voltage rail of the switching power supply.

7. The apparatus of claim 2, wherein, if the reference voltage is greater than a voltage at the first voltage rail and less than a voltage at the second voltage rail, the controller is configured to:
close the first switch;
open the second switch;
control the third switch via a first pulse-width-modulated signal; and
control the fourth switch via a second pulse-width-modulated signal.

8. The apparatus of claim 2, wherein:
the apparatus comprises a switching power supply; and
if the reference voltage is greater than a voltage at the first voltage rail of the switching power supply and less than a voltage at the second voltage rail of the switching power supply, the switching power supply is configured as a boost converter while the inductive element is electrically shorted to the first voltage rail through the first switch.

9. The apparatus of claim 2, wherein, if the reference voltage is greater than a voltage at the second voltage rail, the controller is configured to:
open the first switch;
close the second switch;
control the third switch via a first pulse-width-modulated signal; and
control the fourth switch via a second pulse-width-modulated signal.

10. The apparatus of claim 2, wherein:
the apparatus comprises a switching power supply; and
if the reference voltage is greater than a voltage at the second voltage rail, the switching power supply is configured as a boost converter while the inductive element is electrically shorted to the second voltage rail through the second switch.

11. The apparatus of claim 1, wherein voltages at the first voltage rail and the second voltage rail are generated via a first battery and a second battery.

12. The apparatus of claim 1, wherein each of the first switch, the second switch, the third switch, and the fourth switch comprises a field-effect transistor (FET).

13. A method for voltage regulation, comprising:
comparing an output voltage at an output node to a reference voltage; and
regulating the output voltage by controlling a plurality of switches of a switching power supply based on the comparison, wherein the switching power supply comprises:
a first switch of the plurality of switches;
an inductive element, the first switch being coupled between a first voltage rail and a first terminal of the inductive element;
a second switch of the plurality of switches coupled between a second voltage rail and the first terminal of the inductive element;
a third switch of the plurality of switches coupled between a second terminal of the inductive element and a reference potential node; and
a fourth switch of the plurality of switches coupled between the second terminal of the inductive element and the output node.

14. The method of claim 13, wherein, if the reference voltage is less than a voltage at the first voltage rail, controlling the plurality of switches comprises:
closing the first switch;
opening the second switch;
opening the third switch; and
closing the fourth switch.

15. The method of claim 13, wherein, if the reference voltage is greater than a voltage at the first voltage rail and less than a voltage at the second voltage rail, controlling the plurality of switches comprises:
opening the first switch;
closing the second switch;
opening the third switch; and
closing the fourth switch.

16. The method of claim 13, wherein, if the reference voltage is greater than a voltage at the first voltage rail and less than a voltage at the second voltage rail, controlling the plurality of switches comprises:
opening the third switch;
closing the fourth switch;
controlling the first switch via a first pulse-width-modulated signal; and
controlling the second switch via a second pulse-width-modulated signal.

17. The method of claim 13, wherein controlling the plurality of switches comprises configuring the switching power supply as a buck converter if the reference voltage is greater than a voltage at the first voltage rail of the switching power supply and less than a voltage at the second voltage rail of the switching power supply.

18. The method of claim 13, wherein, if the reference voltage is greater than a voltage at the first voltage rail and less than a voltage at the second voltage rail, controlling the plurality of switches comprises:
closing the first switch;
opening the second switch;
controlling the third switch via a first pulse-width-modulated signal; and
controlling the fourth switch via a second pulse-width-modulated signal.

19. The method of claim 13, wherein, if the reference voltage is greater than a voltage at the first voltage rail of the switching power supply and less than a voltage at the second voltage rail of the switching power supply, controlling the plurality of switches comprises configuring the switching power supply as a boost converter while the inductive element is electrically shorted to the first voltage rail through the first switch.

20. The method of claim 13, wherein, if the reference voltage is greater than a voltage at the second voltage rail, controlling the plurality of switches comprises:
opening the first switch;
closing the second switch;
controlling the third switch via a first pulse-width-modulated signal; and
controlling the fourth switch via a second pulse-width-modulated signal.

21. The method of claim 13, wherein, if the reference voltage is greater than a voltage at the second voltage rail, controlling the plurality of switches comprises configuring the switching power supply as a boost converter while the inductive element is electrically shorted to the second voltage rail through the second switch.

22. The method of claim 13, wherein voltages at the first voltage rail and the second voltage rail are generated via a first battery and a second battery.

23. The method of claim 13, wherein each of the first switch, the second switch, the third switch, and the fourth switch comprises a field-effect transistor (FET).

24. An apparatus for voltage regulation, comprising:
an inductive element;
means for selectively coupling a first terminal of the inductive element to a first voltage rail;
means for selectively coupling the first terminal of the inductive element to a second voltage rail;
means for selectively coupling a second terminal of the inductive element to a reference potential node; and
means for selectively coupling the second terminal of the inductive element to an output node.

25. The apparatus of claim 24, further comprising:
means for comparing an output voltage at the output node to a reference voltage; and
means for regulating the output voltage by controlling the means for selectively coupling the first terminal of the inductive element to the first voltage rail, the means for selectively coupling the first terminal of the inductive element to the second voltage rail, the means for selectively coupling the second terminal of the inductive element to the reference potential node, and the means for selectively coupling the second terminal of the inductive element to the output node, based on the comparison.
